(19) United States
(12) Patent Application Publication
(10) Pub. No.: US 2014/0193120 A1
(43) Pub. Date: Jul. 10, 2014

(54) FERRULE ASSEMBLY WITH INTEGRAL LATCH

(71) Applicants: Malcolm H. Hodge, Chicago, IL (US); Wenzong Chen, Naperville, IL (US); Dean Richardson, Wilmette, IL (US); Scot A. Ennst, Plainfield, IL (US); Thomas D. Chiltz, Naperville, IL (US); Thomas R. Marrapose, Naperville, IL (US)

(72) Inventors: Malcolm H. Hodge, Chicago, IL (US); Wenzong Chen, Naperville, IL (US); Dean Richardson, Wilmette, IL (US); Scot A. Ennst, Plainfield, IL (US); Thomas D. Chiltz, Naperville, IL (US); Thomas R. Marrapose, Naperville, IL (US)

(73) Assignee: Molex Incorporated, Lisle, IL (US)

(21) Appl. No.: 14/123,544

(22) PCT Filed: Jun. 14, 2012
(86) PCT No.: PCT/US12/42436

§ 371 Date: Feb. 28, 2014

Related U.S. Application Data
(60) Provisional application No. 61/496,715, filed on Jun. 14, 2011.

(51) Int. Cl. G02B 6/38; G02B 6/32; G02B 6/40

(52) U.S. Cl. CPC G02B 6/3893; G02B 6/403; G02B 6/32
USPC 385/79; 385/81

(57) ABSTRACT

An optical fiber assembly includes a ferrule body with a plurality of optical fibers positioned therein. The assembly may include a beam expanding element adjacent the front face of the ferrule body with a lens array aligned with the optical fibers. A resilient latch is integrally formed with the beam expanding element or the ferrule body.

### REFERENCE To RELATED APPLICATIONS

The Present Disclosure claims priority to prior-filed U.S. Provisional Patent Application No. 61/496,715, entitled “Paroli-Type Ferrule Assembly,” filed on 14 Jun. 2011 with the United States Patent And Trademark Office. The content of the aforementioned Patent Application is incorporated in its entirety herein.

### BACKGROUND OF THE PRESENT DISCLOSURE

The Present Disclosure relates generally to optical fiber ferrule assemblies and, more particularly, to a multi-fiber ferrule assembly with an integrally formed latch to secure the ferrule assembly to a mating component.

Systems for interconnecting optical fibers typically utilize mating ferrule assemblies to facilitate handling and accurate positioning of the fibers. The optical fibers are secured within a ferrule body with an end surface of each fiber being positioned generally flush with or slightly protruding from an end face of the ferrule body. The end surfaces or faces of the fibers are often polished to desired finish. When complementary ferrules assemblies are mated, each optical fiber of one ferrule assembly is aligned with a mating optical fiber of the other ferrule assembly.

In some applications, the end faces of the mating optical fibers physically contact one another in order to effect signal transmission between the mating optical fiber pair. In other applications, the end faces are spaced apart and the optical beams of each fiber are expanded and transmitted over an air gap between the optical fibers. In either case, it is desirable to securely fix each ferrule assembly to its mating component.

Latching assemblies are often used to removably secure the ferrule assembly to its mating component. These latching assemblies are often formed on a housing or another structure in which the ferrule assembly is fixed. Such additional structure increases the cost and complexity of the system. It is desirable to provide a multi-fiber ferrule assembly having an integral latch to reduce the complexity and cost of the optical fiber components.

### SUMMARY OF THE PRESENT DISCLOSURE

In one aspect, an optical fiber assembly includes a plurality of generally parallel optical fibers. A ferrule body has the plurality of optical fibers positioned therein and a front face with the end face of each optical fiber being positioned generally adjacent the front face. A beam expanding element is generally adjacent the front face of the ferrule body and has a lens array aligned with the optical fibers. A resilient latch for interconnecting the optical fiber assembly to a mating component is integrally formed with the beam expanding element.

In another aspect, an optical fiber assembly includes a plurality of generally parallel optical fibers. A ferrule body directly engages optical fibers that are positioned therein. An end face of each optical fiber is positioned generally adjacent the front face of the ferrule body. A beam expanding element is generally adjacent the front face of the ferrule body and has a lens array aligned with the optical fibers. A resilient latch for interconnecting the optical fiber assembly to a mating component is integrally formed with the ferrule body or the beam expanding element.

In still another aspect, an optical fiber assembly includes a ferrule body directly engaging a plurality of optical fibers positioned therein. The ferrule body has a front face and the end face of each optical fiber is positioned generally adjacent the front face. A resilient latch for interconnecting the optical fiber assembly to a mating component is integrally formed with the ferrule body.

### BRIEF DESCRIPTION OF THE FIGURES

The organization and manner of the structure and operation of the Present Disclosure, together with further objects and advantages thereof, may best be understood by reference to the following Detailed Description, taken in connection with the accompanying Figures, wherein like reference numerals identify like elements, and in which:

FIG. 1 is a perspective view of an embodiment of a terminated ferrule assembly;

FIG. 2 is an exploded perspective view of the ferrule assembly of FIG. 1;

FIG. 3 is a perspective view of a ferrule assembly inserted into an adapter and a second ferrule assembly aligned for insertion therein;

FIG. 4 is a section taken generally along Line 4-4 of FIG. 3;

FIG. 5 is a perspective view of an alternate embodiment of a terminated ferrule assembly; and

FIG. 6 is an exploded perspective view of the ferrule assembly of FIG. 5.

### DESCRIPTION OF THE PREFERRED EMBODIMENTS

While the Present Disclosure may be susceptible to embodiment in different forms, there is shown in the Figures, and will be described herein in detail, specific embodiments, with the understanding that the Present Disclosure is to be considered an exemplification of the principles of the Present Disclosure, and is not intended to limit the Present Disclosure to that as illustrated.

As such, references to a feature or aspect are intended to describe a feature or aspect of an example of the Present Disclosure, not to imply that every embodiment thereof must have the described feature or aspect. Furthermore, it should be noted that the description illustrates a number of features. While certain features have been combined together to illustrate potential system designs, those features may also be used in other combinations not expressly disclosed. Thus, the depicted combinations are not intended to be limiting, unless otherwise noted.

In the embodiments illustrated in the Figures, representations of directions such as up, down, left, right, front and rear, used for explaining the structure and movement of the various elements of the Present Disclosure, are not absolute, but relative. These representations are appropriate when the elements are in the position shown in the Figures. If the description of the position of the elements changes, however, these representations are to be changed accordingly.

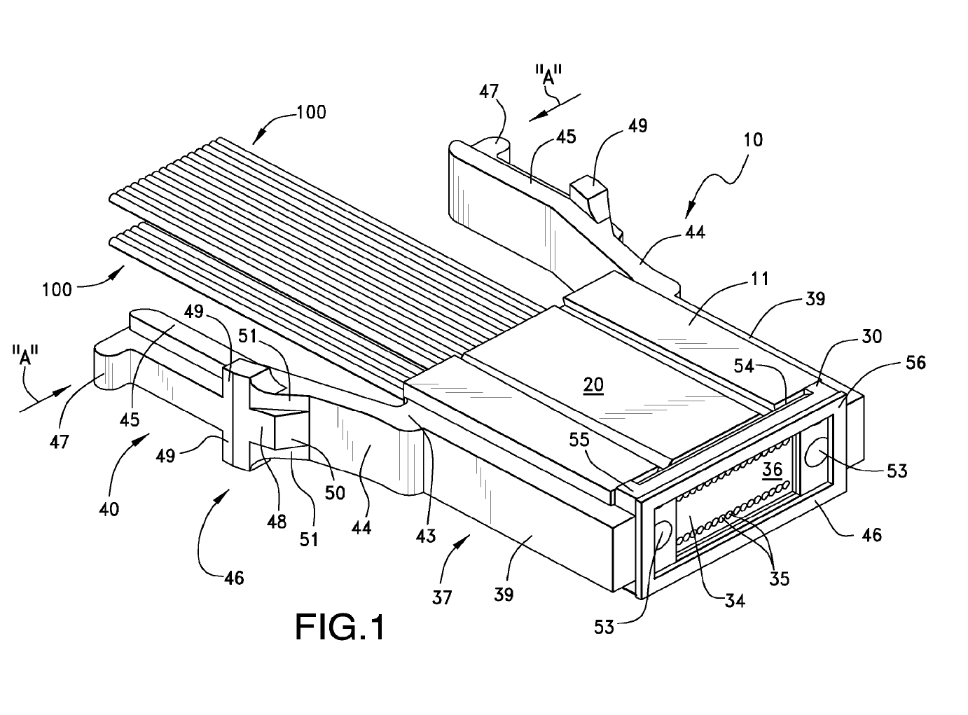

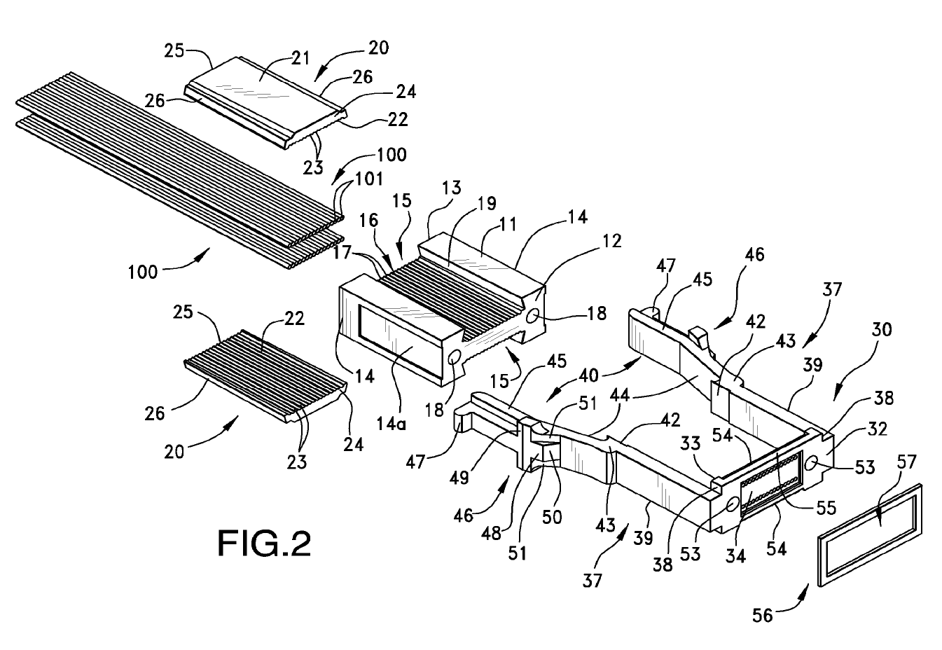

Referring to FIGS. 1-2, an optical fiber assembly such as a multi-fiber lensed ferrule assembly 10 is illustrated. The ferrule assembly includes a ferrule body 11 having a plurality of optical fibers 100 secured thereto. A light or beam expanding element such as lens plate 30 may be fixed to the ferrule body 11. As depicted, ferrule assembly 10 includes two rows of 16 optical fibers 100 although the ferrule assembly may be configured to receive greater or fewer optical fibers if desired.

Ferrule body 11 is generally rectangular and has a generally planar front face 12, a generally planar rear face 13 and oppositely facing sidewalls 14. Each sidewall 14 may include a latch registration or alignment channel 14a that extends from the front face 12 of the ferrule body 12 towards the rear face 13. A pair of oppositely facing optical fiber receiving nests 15 extend between the front face 12 and the rear face 13. The optical fiber receiving nests 15 are configured to receive the optical fibers 100 in a side-by-side configuration with each of the optical fibers being generally parallel to each other. Each optical fiber receiving nest 15 has an optical fiber engaging or registration surface 16 for positioning and supporting each optical fiber 100 positioned within the optical fiber receiving nest 15.

The registration surface 16 may include a plurality of arcuate or scalloped sections 17. Each arcuate section 17 supports one of the optical fibers 100. If the optical fibers 100 are formed of a plastic material that is generally easily deformed, the arcuate sections 17 are desirable not only to align the optical fibers but also support the optical fibers and prevent their deformation. Deformation of the optical fibers (e.g., changing their cross-section from circular to oval or creating a flat surface) may negatively impact the optical performance of such optical fiber. If the optical fibers 100 inserted into the ferrule body 11 are formed of glass, the arcuate section 17 may not be necessary for supporting the optical fibers to prevent deformation but may still be useful for accurate positioning of each optical fiber.

Ferrule body 11 may include a pair of alignment holes 18 that extend rearwardly through the front face 12. The alignment holes are positioned on the horizontal centerline of the front face 12. The alignment holes 18 may be generally cylindrical and extend through the ferrule body 11 between the front face 12 and rear face 13. The alignment holes 18 are configured to receive a post (not shown) therein to facilitate alignment when mating a pair of optical fiber assemblies.

An alignment cover 20 is configured to be received within each optical fiber receiving nest 15 to secure the optical fibers 100 within the optical fiber receiving nest 15. Each alignment cover 20 may be generally rectangular with an outer surface 21 and an oppositely facing inner surface 22. The outer surface 21 may be generally planar and the inner surface 22 may include a plurality of arcuate or scalloped sections 23 that correspond to the arcuate section 17 of the optical fiber receiving nest 15 to position and support the optical fibers 100. As with the arcuate sections 17, when securing plastic optical fiber 100, it may desirable to distribute the forces on the optical fibers to reduce deformation of such fibers.

If desired, the optical fiber receiving nests 15 and the alignment covers 20 may be tapered to facilitate assembly of the alignment cover 20 to the ferrule body 11. More specifically, the optical fiber receiving nest may be tapered from the front face 12 of the ferrule body 11 to the rear face 13 so that the optical fiber receiving nest 15 is slightly wider adjacent the front face as compared to the rear face. Similarly, the alignment cover 20 may be tapered from its front face 24 to its rear face 25 so that the alignment cover is slightly wider adjacent the front face as compared to the rear face. As such, the alignment cover 20 is narrower adjacent its rear face 25 than the optical fiber receiving nest 15 adjacent its front face 12. This configuration permits the alignment cover 20 to be inserted from the front face 12 of the ferrule body 11 and moved rearwardly towards the rear face 13 until the sidewalls 26 of the alignment cover 20 fully engage the inner walls 19 of the ferrule body 11.

The inner walls 19 of the ferrule body 11 and the sidewalls 26 of alignment cover 20 may be sloped so that insertion of the alignment cover 20 into the optical fiber receiving nest 15 secures the optical fibers in place and the alignment covers do not require any additional latch mechanisms. If desired, the inner walls 19 of the ferrule body 11 and the sidewalls 26 of the alignment cover 20 may also taper or slope downward so that sliding movement of the alignment cover 20 into the optical fiber receiving nest 15 also moves the inner surface 22 of the alignment cover 20 towards the optical fiber registration surface 16 of the optical fiber receiving nest 15.

Each of the arcuate sections 17 of the optical fiber receiving nest 15 is aligned with one of arcuate sections 23 of the alignment cover 20. The spacing of the arcuate sections 17 along the registration surface 16 of optical fiber receiving nest 15 and the spacing of the arcuate sections 23 along the inner surface 22 of the alignment cover 20 may be set as desired. The arcuate sections 17 and arcuate sections 23 may be configured so that the arrays of optical fibers 100 are uniformly spaced either with adjacent optical fibers touching each other or with a gap between adjacent optical fibers. In a further alternate embodiment, the arcuate sections 17 and arcuate sections 23 may be configured so that the arrays of optical fibers 100 are grouped together with a relatively small space or gap between the groups of optical fibers. This may be desirable to facilitate the termination of plastic optical fibers.

Ferrule body 11 and the alignment covers 20 may be formed of a resin capable of being injection molded such as polyphenylene sulfide or polyetherimide and may include an additive such as silica (SiO2) to increase the strength and stability of the resin. Other materials may be used as desired.

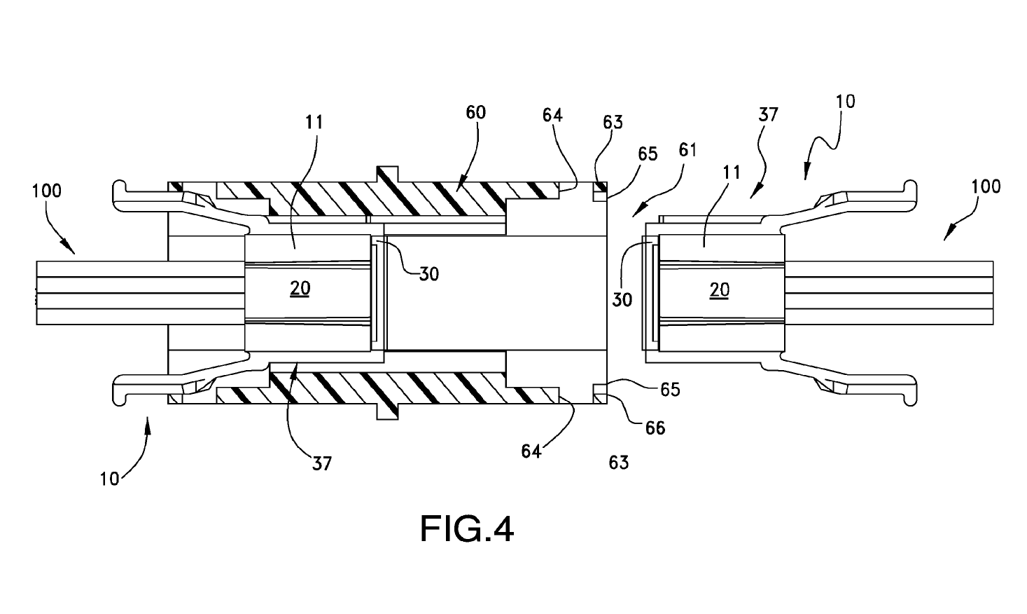

Lens plate 30 is generally rectangular and has a front face 32 and a rear face 33. Lens plate 30 may be formed of an optical grade resin that is capable of being injection molded with a refractive index closely matching that of the optical fibers 100. In one example, the lens plate may be formed of Ultem®. A recess 34 may be centrally located in the front face 32 of the lens plate 30 and includes a plurality of lens elements 35. One lens element is aligned with each optical fiber 100 when the lens plate 30 is secured to the front face 12 of the ferrule body 11. In the depicted embodiment, the lens elements 35 are of the cross-focusing type and include a convex shape (FIG. 4) projecting from the bottom surface 36 of recess 34 towards the front face 32 of lens plate 30. The rear face 33 of lens plate 30 may be positioned adjacent the front face 12 of ferrule body 11 with an end face 101 of each optical fiber 100 engaging the rear face 33 of lens plate 30.

A cantilevered arm 37 may project rearwardly from each sidewall 38 of lens plate 30. Arm 37 includes a forward section 39 and a rearward latch arm 40. Forward section 39 is generally linear and extends rearwardly from the front face 32 adjacent the sidewall 38 of lens plate 30. Forward section 39 may be approximately equal in length to ferrule body 11. An inner surface 41 of forward section 39 extends along the sidewall 14 of ferrule body 11. If sidewall 14 of ferrule body 11 includes a latch alignment channel 14a, the inner surface 41 may be dimensioned to be received within the alignment channel. As depicted in FIG. 2, the latch alignment channel 14a does not extend to the rear face 13 of ferrule body 11. Accordingly, inner surface 41 of the forward section 39 has a recess or step 42 adjacent the rear edge 43 of the forward section so that the inner surface 41 extends along and is adjacent to the entire length of the sidewall 14 of ferrule body 11. Other configurations are anticipated.

Rearward latch arm 40 includes a first angled section 44 that extends rearwardly from the rear edge 43 of the forward section 39 and a generally linear section 45 that extend rearwardly from the first angled section. A latch member 46 is positioned at the intersection of the angled section 44 and the linear section 45 to lock the ferrule assembly 10 to a mating component or adapter 60 as described below. A manually manipulatable projection or tab 47 extends from a rear end of the linear section 45 to permit the rearward latch arm 40 to be deflected so that ferrule assembly 10 may be removed from adapter 60.

Latch member 46 is somewhat T-shaped and includes a central alignment projection 48 and an engagement section 49 rearward of the alignment projection that is wider than the alignment projection. If desired, the alignment projections 48 of the two arms 37 may be configured with different widths or with one offset from the centerline of the latch member 46 to provide a polarizing feature so that the ferrule assembly 10 may only be inserted into the adapter 60 in one orientation.

The alignment projection 48 includes a ramped forward surface 50 and the engagement section 49 includes a ramped surface 51 on opposite sides of the ramped forward surface 50. The ramped forward surface 50 and the ramped surfaces 51 facilitate deflection of the rearward latch arm 40 when inserting the ferrule assembly 10 into a mating component or adapter 60 as described below. The engagement section 49 also includes a rearwardly facing locking surface 52 behind each of the ramped surfaces 51 to lock the ferrule assembly 10 in the adapter 60. If desired, the rearwardly facing locking surface may be sloped or angled so as to provide a forward or mating bias to the ferrule assemblies. More specifically, when the ferrule assembly 10 is inserted into adapter 60, the locking surface 52 engages the rearward edge 67 of the windows 64 and biases the ferrule assembly forward.

Upon mounting lens plate 30 on ferrule body 11, the forward section 39 of arm 37 extends along the sidewall 14 of ferrule body 11 and the rearward latch arm 40 extends rearwardly of the ferrule body. Accordingly, upon pressing the tab 47 inwardly as shown by arrows “A,” the rearward latch arm 40 will be deflected inwardly towards optical fibers 100. The forward section 39 of each arm 37 will remain along the sidewall 14 of the ferrule body 11.

Lens plate 30 may include a pair of cylindrical guide holes or receptacles 53 that are configured to be aligned with the alignment holes 18 of ferrule body 11. Each guide hole 53 may be configured to have a diameter that matches or is larger than that of the alignment holes 18 of ferrule body 11.

Lens plate 30 may have a pair of circular spacers or pedestals (not shown) projecting from rear face 33 with one surrounding each guide hole 53. The length of the spacers may be chosen so as to define a consistent and predetermined distance or gap between the front face 12 of ferrule body 11 and the rear face 33 of lens plate 30. A reservoir 54 may be provided in the upper and lower surfaces 55 of lens plate 30 to facilitate the application of an index-matched medium such as an epoxy between the end faces 101 of the optical fibers 100 and the rear face 33 of the lens plate 30.

A resilient gasket 56 may be secured to the front face 32 of lens plate 30 to seal to some extent the mating interface between a pair of mated ferrule assemblies 10. The gasket 56 as depicted is generally rectangular with a central opening 57 that surrounds the lens elements 35. The gasket 56 may be other shapes depending on the configuration of the mating interface.

During assembly, a plurality of optical fibers 100 are positioned within one of the optical fiber receiving nest 15 of ferrule body 11. Each of the optical fibers 100 are positioned so as to engage the arcuate sections 17 of the optical fiber registration surface 16 within the optical fiber receiving nest 15.

An alignment cover 20 is positioned adjacent optical fiber receiving nest 15 with the rear face 25 of the alignment cover 20 generally adjacent the front face 12 of the ferrule body 11. The alignment cover 20 is positioned so that each of the arcuate sections 23 of the inner surface 22 is aligned with one of the optical fibers 100. The alignment cover 20 may then be moved relative to the ferrule body from the front face 12 towards the rear face 13. The tapered inner walls 19 of the ferrule body 11 and tapered sidewalls 26 of alignment cover 20 will cause the alignment cover 20 to be secured in place with the optical fibers 100 sandwiched between the ferrule body 11 and the alignment cover 20. If desired, an adhesive such as epoxy may be applied to the optical fibers 100 within the optical fiber receiving nest 15 and to inner surface 22 of alignment cover 20 to further secure the ferrule body 11, the alignment cover 20 and the optical fibers 100. If the ferrule body 11 includes an additional optical fiber receiving nest 15, the process may be repeated to secure optical fibers 100 within such optical fiber receiving nest 15.

After the optical fibers 100 are secured within the optical fiber receiving nests 15 of the ferrule body 11, the optical fibers may be cleaved or terminated generally adjacent front face 12. Additional processing of the end faces 101 of the optical fibers 100 may be performed if desired. For example, if the optical fibers are made of glass, it may be desirable to polish the end faces 101 as is known in the art.

The lens plate 30 may then be secured to the ferrule body 11 by applying an adhesive between the front face 12 of the ferrule body and the rear face 33 of the lens plate 30. In one embodiment, a fixture (not shown) may be used to position the lens plate 30 adjacent the front face 12 of the ferrule body 11 and an adhesive such as epoxy applied to the reservoir 40 adjacent the upper and lower surfaces 41 of the lens plate 30. The adhesive will travel from the reservoir 40 and along the gap between the front face 12 of ferrule body 11 and the rear face 33 of lens plate 30 to secure the lens plate to the ferrule body and create a uniform gap 42 between the end faces 101 of the optical fibers 100 and the lens elements 35 of the lens plate. In many instances, it may be desirable to utilize an adhesive having an index of refraction that generally matches that of the lens plate 30 and the optical fibers 100 to maximize light transmission. If desired, an adhesive such as epoxy may also be applied between the sidewalls 14 of ferrule body 11 and the forward section 39 of each arm 37. Through such a configuration, the arms 37 are integrally formed with the lens plate 30 and function to latch the ferrule assembly 10 to a mating component such as an adapter.

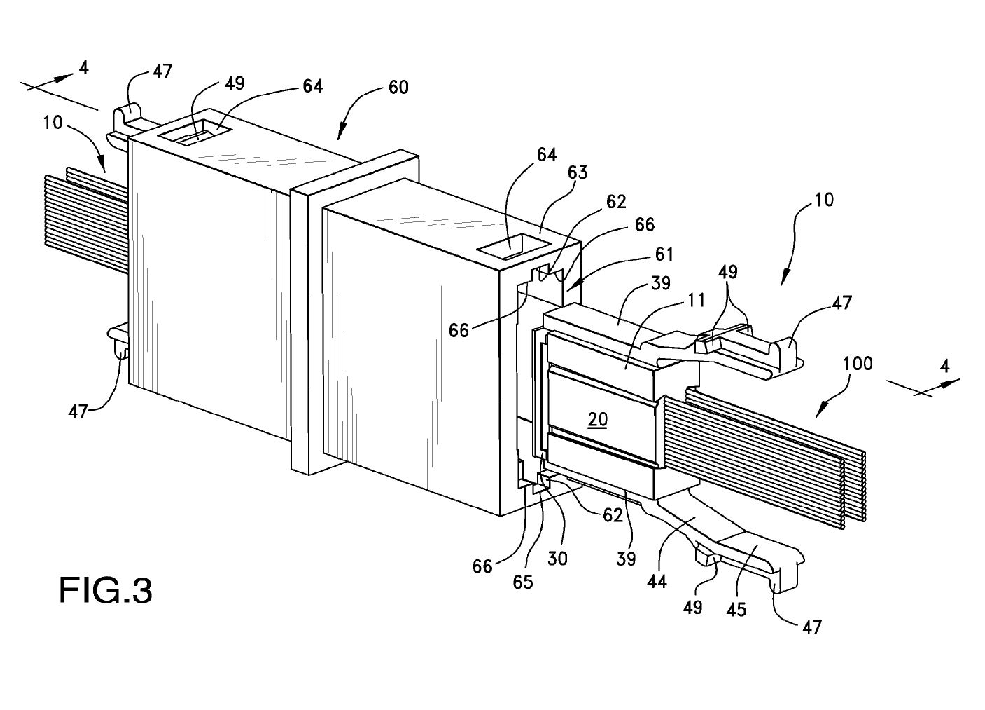

Referring to FIGS. 3-4, an adapter 60 is depicted with one ferrule assembly 10 inserted therein and a second ferrule assembly aligned for insertion. Adapter 60 includes a generally rectangular opening 61 to receive each ferrule assembly 10. A notch or recess 62 extends outwardly from the opening 61 towards each end wall 63. The notches 62 are configured to receive the alignment projections 48 of the latch member 46 to align the ferrule assembly 10 with the adapter 60 during mating. A window or opening 64 is provided in the end walls 63 to lockingly receive the engagement section 49 of the latch member 46 to secure the ferrule assembly 10 within the adapter 60.

As the ferrule assembly 10 is inserted into the opening 61 in the adapter, the ramped forward surface 50 will engage the outer edge 65 in the notch 62 and the ramped surfaces 51 of the engagement section 49 will engage the outer edge 66 of the opening 61. The angle of the ramped forward surface 50 and the ramped surfaces 51 will cause the rearward latch arm 40 to deflect during the insertion process. The rearward latch arms 40 will remain deflected until the engagement sections 49 are aligned with the windows 64 in the adapter 60. The resiliency of the rearward latch arms 40 will cause the rearward latch arms to spring outward towards their undflected positions and the engagement sections 49 will enter the windows 64. The rearwardly facing locking surfaces 52 of each engagement section 49 will engage a rearward edge 67 of the windows 64 to secure the ferrule assembly 10 within the adapter 60. The ferrule assembly 10 may be removed from the adapter 60 by pressing the tabs 47 inwardly until the rearwardly facing locking surfaces 52 of each engagement section 49 no longer engages the rearward edge 67 of its windows 64.

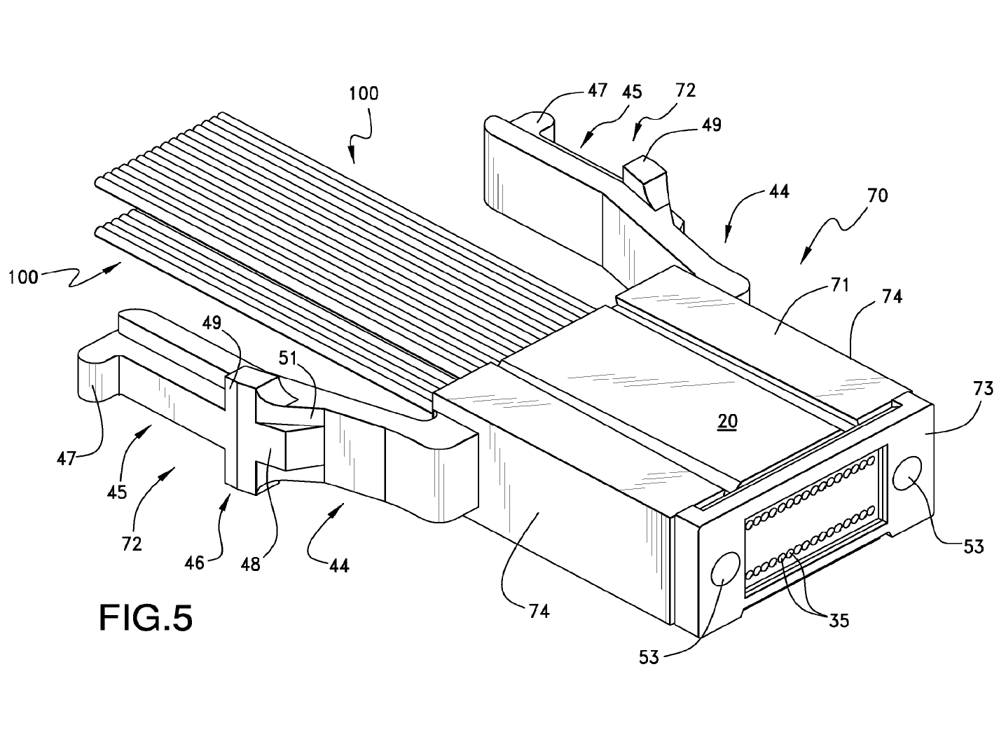

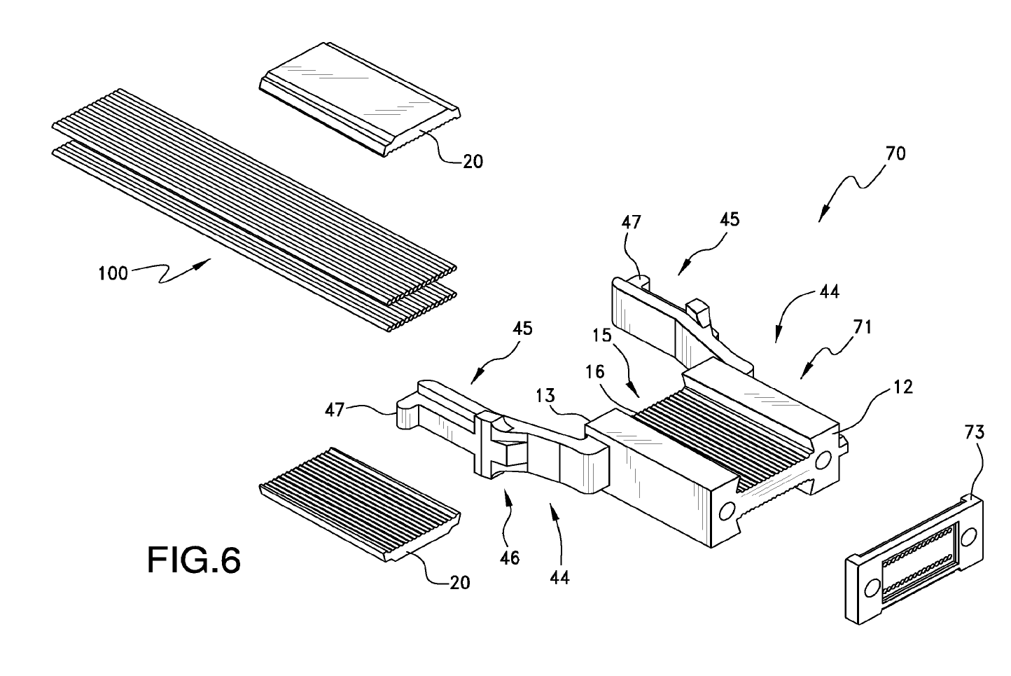

In an alternate embodiment depicted in FIGS. 5-6, ferrule assembly 70 includes resilient latch arms 72 that are integrally formed with the ferrule body 71. Like reference numbers are used to depict like components and the description thereof is not repeated herein. As such, the forward section 39 of each arm 37 of lens plate 73 is eliminated and the latch arms 72 extend from the sidewalls 74 of ferrule body 71. The latch arms 72 and the components thereof function as described above with respect to rearward latch arms 40 of arms 37.

In an alternate embodiment, the lens plate 30 may be eliminated from the ferrule assembly 70 so that the optical fibers 100 of one ferrule assembly are mated directly with another similarly configured ferrule assembly (not shown).

While a preferred embodiment of the Present Disclosure is shown and described, it is envisioned that those skilled in the art may devise various modifications without departing from the spirit and scope of the foregoing Description and the appended Claims.

What is claimed is:

1. An optical fiber assembly comprising:
a plurality of generally parallel optical fibers, each optical fiber having an end face;
a ferrule body having the plurality of optical fibers positioned therein, the ferrule body having a front face, the end face of each optical fiber being positioned generally adjacent the front face of the ferrule body;
a beam expanding element generally adjacent the front face of the ferrule body, the beam expanding element having a lens array aligned with the optical fibers of ferrule body; and
a resilient latch for interconnecting the optical fiber assembly to a mating component, the resilient latch being integrally formed with the beam expanding element.

2. The optical fiber assembly of claim 1, further including a pair of rearwardly extending, cantilevered resilient latch arms.

3. The optical fiber assembly of claim 2, wherein each latch arm has a latching projection for engaging a latching shoulder of the mating component.

4. The optical fiber assembly of claim 1, further including a generally elongated member integrally formed with and extending between the beam expanding element and the resilient latch.

5. The optical fiber assembly of claim 4, wherein the generally elongated member extends along a sidewall of ferrule body generally from the front face of the ferrule body towards a rear face of the ferrule body.

6. The optical fiber assembly of claim 5, wherein the generally elongated member is fixed to the sidewall of the ferrule body.

7. The optical fiber assembly of claim 5, wherein the generally elongated member is generally non-deflectable.

8. The optical fiber assembly of claim 1, wherein the mating component is an adapter configured to mate with another ferrule assembly.

9. An optical fiber assembly comprising:
a plurality of generally parallel optical fibers, each optical fiber having an end face;
a ferrule body directly engaging the optical fibers positioned therein, the ferrule body having a front face, the end face of each optical fiber being positioned generally adjacent the front face of the ferrule body;
a beam expanding element generally adjacent the front face of the ferrule body, the beam expanding element having a lens array aligned with the optical fibers of ferrule body, the lens array being spaced from the optical fibers by a predetermined distance; and
a resilient latch for interconnecting the optical fiber assembly to a mating component, the resilient latch being integrally formed with one of the ferrule body and the beam expanding element.

10. The optical fiber assembly of claim 9, further including a pair of rearwardly extending, cantilevered resilient latch arms.

11. The optical fiber assembly of claim 10, wherein each latch arm has a latching projection for engaging a latching shoulder of the mating component.

12. The optical fiber assembly of claim 9, wherein the mating component is an adapter configured to mate with another ferrule assembly.

13. An optical fiber assembly comprising:
a plurality of generally parallel optical fibers, each optical fiber having an end face;
a ferrule body directly engaging optical fibers positioned therein, the ferrule body having a front face, the end face of each optical fiber being positioned generally adjacent the front face of the ferrule body; and
a resilient latch for interconnecting the optical fiber assembly to a mating component, the resilient latch being integrally formed with the ferrule body.

14. The optical fiber assembly of claim 13, where in the resilient latch has a pair of rearwardly extending, cantilevered resilient latch arms.

15. The optical fiber assembly of claim 14, wherein each latch arm has a latching projection for engaging a latching shoulder of the mating component.

16. The optical fiber assembly of claim 15, wherein the latch arm has a secondary projection for engaging the mating component and biasing the ferrule body towards a mating optical fiber assembly.
